(19) United States
(12) Patent Application Publication
(10) Pub. No.: US 2026/0244343 A1
(43) Pub. Date: Aug. 20, 2026

(54) MEMORY SYSTEM AND MEMORY CONTROLLER

(71) Applicant: Kioxia Corporation, Tokyo (JP)

(72) Inventor: Yuki TAYU, Yokohama (JP)

(73) Assignee: Kioxia Corporation, Tokyo (JP)

(21) Appl. No.: 19/286,417

(22) Filed: Jul. 31, 2025

(30) Foreign Application Priority Data
Feb. 14, 2025 (JP) 2025-022313

(51) Int. Cl. G06F 3/06

(52) U.S. Cl. CPC G06F 3/061; G06F 3/0634; G06F 3/0659; G06F 3/0679

(57) ABSTRACT

According to one embodiment, a controller supports a first write mode and a second write mode as a data write mode to a nonvolatile memory. The first write mode writes 1 bit of data to each memory cell. The second write mode writes N bits of data to each memory cell. When receiving a write command to be applied to the first write mode, the controller determines whether amount of write data exceeds a threshold. When the amount is equal to or less than the threshold, the controller writes the write data in the first write mode. When the amount exceeds the threshold, the controller writes at least (amount exceeding over the threshold)+((amount exceeding over the threshold)/(N−1)) of the write data in the second write mode, and writes remaining write data in the first write mode.

### CROSS-REFERENCE TO RELATED APPLICATIONS

This application is based upon and claims the benefit of priority from Japanese Patent Application No. 2025-022313, filed Feb. 14, 2025, the entire contents of which are incorporated herein by reference.

### FIELD

Embodiments described herein relate generally to a memory system and a memory controller.

### BACKGROUND

Memory systems comprising flash memories have been widely prevailing. Currently, Triple Level Cell (TLC)-type memory systems support write in Single Level Cell (SLC) mode in addition to write in TLC mode. Further, Quad Level Cell (QLC)-type memory systems support write in the SLC mode in addition to write in QLC mode.

Sequential write performance of the SLC mode is higher than those of the TLC mode and the QLC mode. Thus, some memory systems of the TLC type or the QLC type have function such as Write Booster (WB), which utilizes high sequential write performance of the SLC mode as needed.

However, the SLC mode involves a risk of performance deterioration due to deterioration of Write Amplification Factor (WAF) and Garbage Collection (GC) due to physical capacity constraints of a flash memory.

### BRIEF DESCRIPTION OF THE DRAWINGS

FIG. 1 is a diagram showing an example of a configuration of a memory system of a first embodiment.

FIG. 2 is a diagram showing an example of a comparison of write time between SLC mode (with GC) and MLC mode (without GC).

FIG. 3 is a flowchart showing data write processing flow of the memory system of the first embodiment.

FIG. 4 is a diagram showing an example of a configuration of a memory system of a second embodiment.

FIG. 5 is a flowchart showing data write processing flow of the memory system of the second embodiment.

FIG. 6 is a diagram showing an example of a configuration of a memory system of a third embodiment.

FIG. 7 is a diagram showing an example of a write mode for a flash memory determined by a first flag (fWriteBoosterEn flag) and a second flag (fWriteBoosterMLC flag) in the memory system of the third embodiment.

FIG. 8 is a flowchart showing data write processing flow of the memory system of the third embodiment.

FIG. 9 is a diagram showing an example of a configuration of a memory system of the fourth embodiment.

FIG. 10 is a diagram showing an example of a write mode selection table of the memory system of the fourth embodiment.

FIG. 11 is a diagram showing transfer performance of devices for each gear (HS-GEAR) specified in the UFS (Universal Flash Storage) 4.0 standard.

FIG. 12 is a diagram showing the maximum write performance for each gear.

FIG. 13 is a diagram showing write performance for each gear in each write mode.

FIG. 14 is a flowchart showing data write processing flow of the memory system of the fourth embodiment.

FIG. 15 is a flowchart showing a modified example of the data write processing flow of the memory system of the fourth embodiment.

FIG. 16 is a flowchart showing data write processing flow of a memory system of the fifth embodiment.

### DETAILED DESCRIPTION

In general, according to one embodiment, a memory system includes a nonvolatile memory and a memory controller. The nonvolatile memory includes a plurality of blocks each including a plurality of memory cells. The memory controller is capable of connecting to a host, and controls the nonvolatile memory. The memory controller supports a first write mode and a second write mode as a data write mode to the nonvolatile memory. The first write mode is a mode which writes 1 bit of data to each memory cell. The second write mode is a mode which writes N (N is a natural number of 2 or more) bits of data to each memory cell. When receiving a write command from the host to be applied to the first write mode, the memory controller determines whether or not amount of write data exceeds a threshold. The threshold is obtained by subtracting a predetermined value from remaining capacity of the nonvolatile memory. The predetermined value indicates remaining capacity of the nonvolatile memory at which garbage collection is triggered to increase remaining capacity of the nonvolatile memory. When the amount of the write data is equal to or less than the threshold, the memory controller writes the write data to the nonvolatile memory in the first write mode. When the amount of the write data exceeds the threshold, the memory controller writes at least (amount exceeding over the threshold)+((amount exceeding over the threshold)/(N−1)) of the write data to the nonvolatile memory in the second write mode, and writes remaining write data to the nonvolatile memory in the first write mode.

Embodiments is described hereinafter with reference to the accompanying drawings.

### First Embodiment

First, the first embodiment is described.

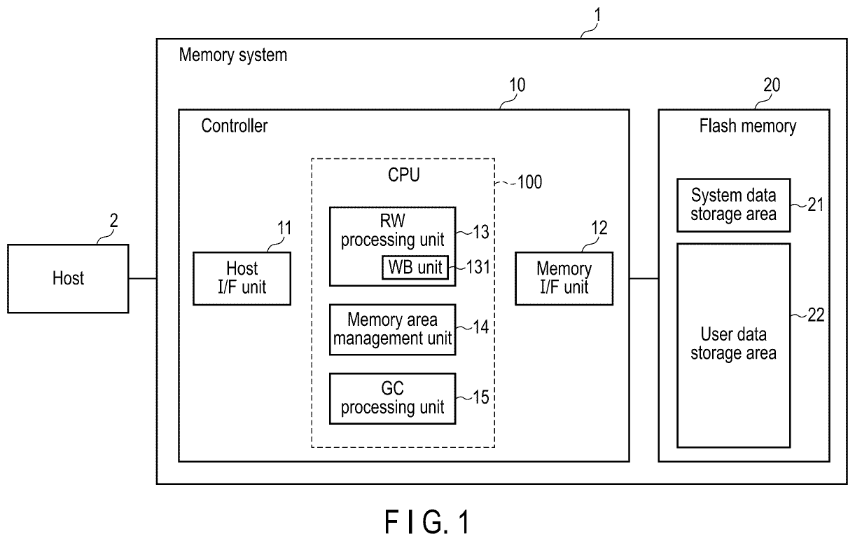

FIG. 1 is a diagram showing an example of a configuration of a memory system 1 of the first embodiment. FIG. 1 shows the memory system 1 connected to a host 2 and constituting an information processing system together with the host 2. The host 2 is an information processing device such as a personal computer or a server.

The memory system 1 includes a controller 10 (a memory controller) and a flash memory 20.

The controller 10 controls the flash memory 20. More specifically, the controller 10 controls the data write processing to the flash memory 20 or the data read processing from the flash memory 20 in response to commands from the host 2. The controller 10 may spontaneously control the data write processing to the flash memory 20 and the data read processing from the flash memory 20 for the management of the flash memory 20, independently of the commands from the host 2. The controller 10 is implemented as a System on Chip (SoC) or the like.

The flash memory 20 is a nonvolatile storage medium that does not allow overwrite of data in areas where data have already been written. Thus, updating data stored in the flash memory 20 is performed by invalidating old data and writing new data to a different area. The areas where invalidated data are stored become reusable after an erase processing. The flash memory 20 has a plurality of blocks each including a plurality of memory cells. The erase processing is performed per block. For example, a block that has been subjected to the erase processing and thus all areas thereof are in a data writable state is called a free block and the like. Data write to the flash memory 20 is performed in a predetermined number of pages included in each block.

The area of the flash memory 20 is divided into a system data storage area 21 and a user data storage area 22 under the control of the controller 10. The host 2 is supplied with the user data storage area 22. The system data storage area 21 stores data used by the controller 10 for controlling the entire memory system 1, and the like.

The controller 10 includes a host interface unit (host I/F unit) 11, a memory interface unit (memory I/F unit) 12, a read/write processing unit (RW processing unit) 13, a memory area management unit 14, and a GC processing unit 15. The following shows examples in which, among the portions of the controller 10, the host I/F unit 11 and the memory I/F unit 12 are implemented as hardware such as electrical circuits, and the RW processing part 13, the memory area management unit 14, and the GC processing unit 15 are implemented by program referred to as firmware and the like being performed by a Central Processing Unit (CPU) 100 incorporated into the controller 10. The RW processing unit 13, the memory area management unit 14, and the GC processing unit 15 may be implemented as hardware such as electrical circuits, in the same manner as the host I/F unit 11 and the memory I/F unit 12.

For example, the host I/F unit 11 is connected to the host 2 via an interface compliant with the PCIe™ specification and performs control for communication with the host 2 in a protocol compliant with the NVMe™ specification.

The memory I/F unit 12 controls data write to the flash memory 20 and data read from the flash memory 20.

When a read command is received from the host I/F unit 11, the RW processing unit 13 reads the data whose read is requested (read data) from the flash memory 20 via the memory I/F unit 12. The RW processing unit 13 transmits the read data, which the memory I/F unit 12 has read from the flash memory 20, to the host 2 via the host I/F unit 11.

When a write command is received by the host I/F unit 11, the RW processing unit 13 writes the data whose write is requested (write data) to the flash memory 20 via the memory I/F unit 12. When the write of the write data to the flash memory 20 is successful, the RW processing unit 13 notifies the host 2 of the write completion via the host I/F unit 11.

The RW processing unit 13 includes a WB unit 131. The WB unit 131 is a module provided to implement the WB function and manages a first flag (fWriteBoosterEn flag) indicating the write mode to be applied by the RW processing unit 13. The first flag is compliant with the current WB specifications.

The flash memory 20 has a plurality of blocks each including a plurality of memory cells. The RW processing unit 13 can perform write in the SLC mode, which writes 1 bit of data to each memory cell of the flash memory 20, in collaboration with the memory I/F unit 12. Alternatively, the RW processing unit 13 can perform write in the MultiLevel Cell (MLC) mode, which writes 2 bits of data to each memory cell of the flash memory 20. During the on state of the first flag, the RW processing unit 13 writes write data to the flash memory 20 in the SLC mode. During the off state of the first flag, the RW processing unit 13 writes write data to the flash memory 20 in the MLC mode. The following describes an example of the memory system 1 of the present embodiment supporting the SLC mode and the MLC mode. The configuration is not limited to this example. For example, the memory system 1 may support the SLC mode and TLC mode that writes 3 bits of data to each memory cell. Alternatively, the memory system 1 may support the three types of the write mode: the SLC mode, the MLC mode, and the TLC mode. Hereinafter, the write in the SLC mode with the first flag in the on state is referred to as write by WB in some cases.

The following assumes that the SLC mode has the write performance of 3800 MiBps, the MLC mode has the write performance of 2500 MiBps, the TLC mode has the write performance of 835 MiBps, and the QLC mode has the write performance of 69 MiBps. The write performance of write mode signifies the write performance per time.

The first flag managed by the WB unit 131 can switch between the on state and the off state of according to commands referred to as QUERY REQUQEST. That is, the host 2 can specify which of the SLC mode or the MLC mode is used for write of write data to the flash memory 20. Specifically, the host 2 can select the SLC mode by switching the first flag to the on state as necessary.

The sequential write performance of the SLC mode is higher than that of the MLC mode. However, the SLC mode, which consumes twice the memory space compared to the MLC mode, may cause performance degradation due to the occurrence of GC. When the SLC mode is specified during the on state of the first flag and writing all of the write data in the SLC mode would cause performance degradation, the memory system 1 of the first memory voluntarily performs some or all of write of write data in the MLC mode. This configuration can suppress performance degradation. This point is described later.

The memory area management unit 14 manages the status of the flash memory 20. For example, the memory area management unit 14 manages the remaining capacity of the flash memory 20 as information indicating the status of the flash memory 20.

The GC processing unit 15 performs GC processing to generate free blocks, when the remaining capacity of the flash memory 20 managed by the memory area management unit 14 falls below a predetermined value. For example, the GC processing moves valid data within two or more blocks, in which the proportion of areas storing invalidated data is large, to a single block, thereby generating (the number of source blocks)—1 free blocks. Information on the proportion of the areas containing invalidated data in each block is managed by the memory area management unit 14.

As described above, the memory area management unit 14 manages the remaining capacity of the flash memory 20. Thus, it is possible to calculate how much more area needs to be consumed before the remaining capacity of the flash memory 20 falls below a predetermined value. When the RW processing unit 13 writes write data to the flash memory 20 in the SLC mode while the first flag is in the on state, the RW processing unit 13 first subtracts a predetermined value from the remaining capacity of the flash memory 20 to calculate a threshold indicating the amount of data that can be written without triggering GC. Next, the RW processing unit 13 determines whether the amount of the write data exceeds the calculated threshold. When the amount of the write data exceeds the threshold, the RW processing unit 13 decides to combine the SLC mode and the MLC mode to perform write in the SLC mode as much as possible without triggering GC.

Specifically, among the write data, the RW processing unit 13 writes twice the amount exceeding over the threshold in the MLC mode, and writes the remaining amount in the SLC mode. The order of the writes in the MLC mode and the SLC mode is not specified. By performing part of the write in the MLC mode to avoid triggering GC, the memory system 1 of the first embodiment can suppress performance degradation more than in cases where all write data are written in the SLC mode as specified.

With the above control, after writing all write data to the flash memory 20 without triggering GC, if GC can be performed and completed before the next write command is received from the host 2, GC will not be triggered during the next write of the write data. This suppresses performance degradation. Even if the next write command is received from the host 2 during GC, the affect of GC can be mitigated.

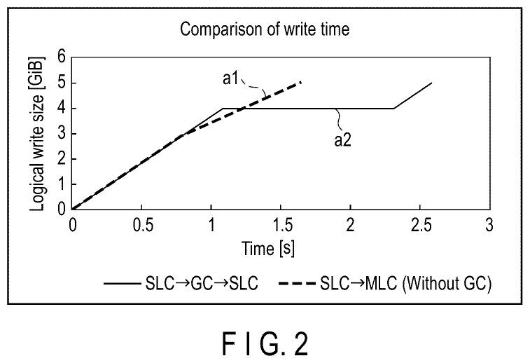

FIG. 2 is a diagram showing an example of a comparison of write time between the SLC mode (with GC) and the MLC mode (without GC).

The following assumes a case where the write is performed with a 5 GiB WB and the threshold for triggering GC is exceeded at the timing when 4 GiB has been written in the SLC mode. At this time, in the memory system 1 of the first embodiment, for example, 3 GiB is written in the SLC mode and the remaining 2 GiB is written in the MLC mode (reference numeral a1 in FIG. 2). Conventional write, which writes all of 5 GiB in the SLC mode (shown by the reference numeral a2) triggers GC, causing performance degradation.

When the memory system 1 of the first embodiment supports both of the SLC mode and the TLC mode, the RW processing unit 13 writes (the amount exceeding over threshold) +((the amount exceeding over the threshold)/2) data among the write data in the TLC mode. In other words, when the memory system 1 of the first embodiment supports the SLC mode and a write mode that writes N bits of data to each memory cell of the flash memory 20, the RW processing unit 13 writes (the amount exceeding over the threshold)+((the amount exceeding over the threshold)/N−1) of the write data in the latter write mode.

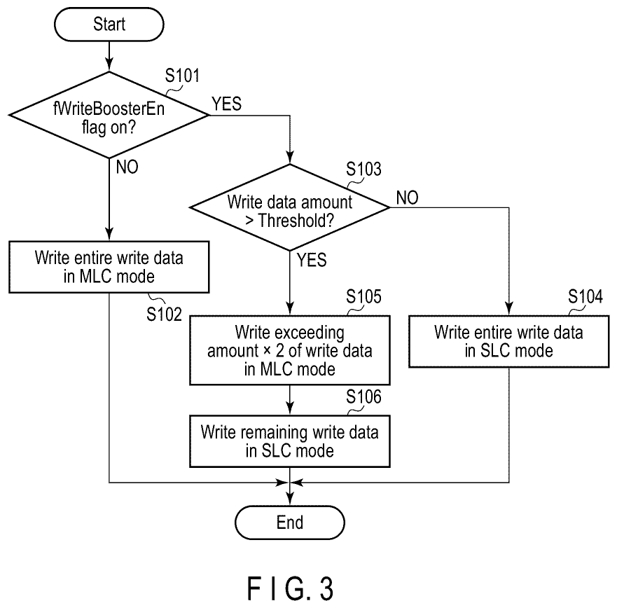

FIG. 3 is a flowchart showing the data write processing flow of the memory system 1 of the first embodiment.

The RW processing unit 13 determines whether the first flag (fWriteBoosterEn flag) is in the on state or not (S101). When the first flag is in the off state (No in S101), the RW processing unit 13 writes all of the write data to the flash memory 20 in the MLC mode (S102). Even when the first flag is in the off state, write may be performed in the SLC mode if other conditions for the SLC mode are satisfied. The following focuses on WB alone.

When the first flag is in the on state (Yes in S101), the RW processing unit 13 determines whether the amount of write data exceeds the threshold (S103). The threshold indicates the amount of data that can be written in the SLC mode without triggering GC. When the amount of write data does not exceed the threshold (No in S103), the RW processing unit 13 writes all of the write data to the flash memory 20 in the SLC mode (S104).

When the amount of the write data exceeds the threshold (Yes in S103), the RW processing unit 13 writes the twice of the amount exceeding the write data to the flash memory 20 in the MLC mode (S105) and writes the remaining write data to the flash memory 20 in the SLC mode (S106). The order of the write in the MLC mode in S105 and the write in the SLC mode in S106 may be reversed.

As described above, when the SLC mode is specified with the first flag in the on state and writing all of the write data in the SLC mode may cause the performance degradation, the memory system 1 of the first embodiment writes some or all of the write data in the MLC mode, suppressing performance degradation.

That is, the memory system 1 of the first embodiment can control the write mode appropriately.

### Second Embodiment

Next, the second embodiment is described.

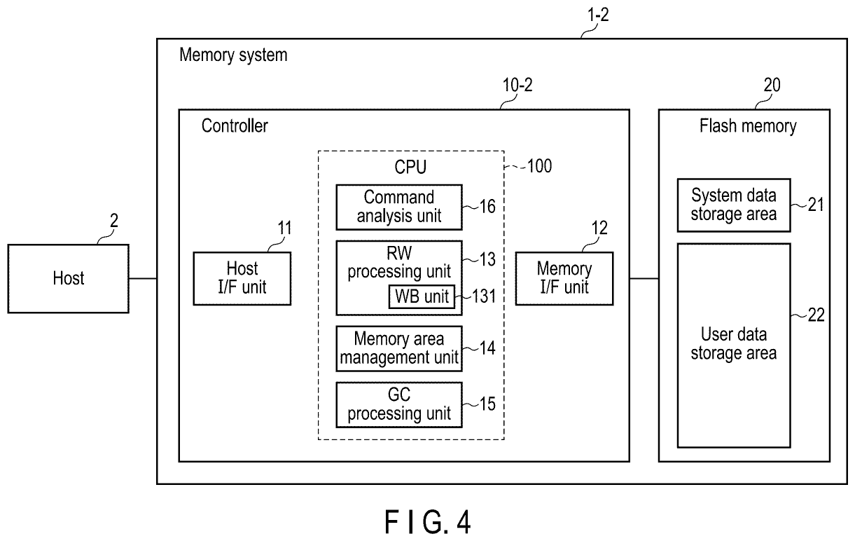

FIG. 4 is a diagram showing an example of a configuration of a memory system 1-2 of the second embodiment. The same reference numerals are used for the same constituent elements as those in the memory system 1 of the first embodiment, and their descriptions are omitted.

A controller 10-2 of the second embodiment includes a command analysis unit 16 in addition to the configuration of the controller 10 of the first embodiment. The following describes an example in which the command analysis unit 16 is implemented by a CPU 100 executing a program such as firmware. The command analysis unit 16 may be implemented as hardware such as an electrical circuit.

When a write command is received from the host 2, the command analysis unit 16 analyzes the write command or a function associated with the write command and determines whether the SLC mode should be applied. The memory system 1 of the first embodiment determines whether the SLC mode should be applied to a write command from the host 2 based on whether the first flag (fWriteBoosterEn flag) is in the on state. In contrast, when the first flag is in the off state, the memory system 1-2 of the second embodiment further determines whether the SLC mode should be applied to the write command from the host 2 based on the analysis performed by the command analysis unit 16.

For example, Force Unit Access (FUA) is a parameter that can instruct immediately writing write data to be nonvolatile without caching the write data. Specifically, by appending an FUA set to “1” to the write command, FUA can instruct immediately writing write data to be the nonvolatile. The command analysis unit 16 determines that the SLC mode should be applied to the write command appended by the FUA set to “1”. In addition to FUA, the command analysis unit 16 can maintain various determination conditions.

When the command analysis unit 16 determines that the SLC mode should be applied, similarly to the memory system 1 of the first embodiment, an RW processing unit 13-2 determines whether the amount of write data of the write command exceeds the threshold. When the amount of the write data does not exceed the threshold, the RW processing unit 13 decides to write all of the write data in the SLC mode. When the amount of the write data exceeds the threshold, the RW processing unit 13 decides to combine the SLC mode and the MLC mode to perform write in the SLC mode as much as possible without triggering GC. The write amounts in the SLC mode and in the MLC mode each are calculated in the same manner as in the memory system 1 of the first embodiment.

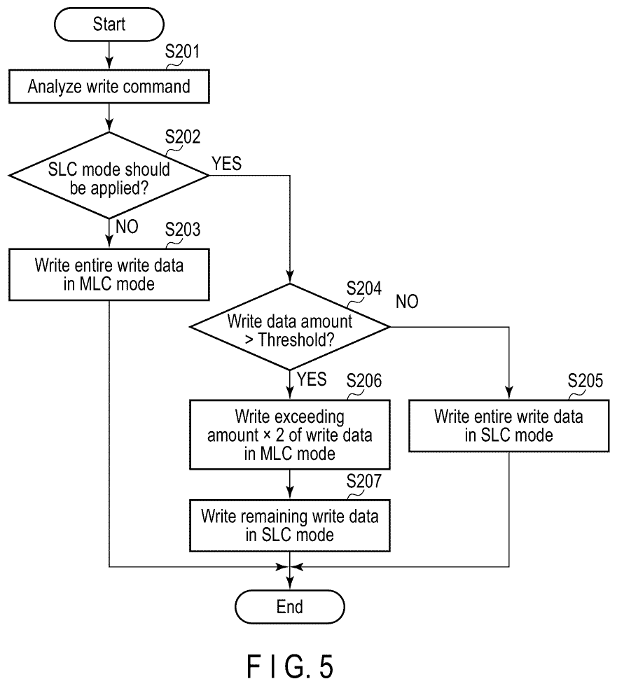

FIG. 5 is a flowchart showing the data write processing flow of the memory system 1-2 of the second embodiment. The following describes an example where the memory system 1-2 of the second embodiment supports the SLC mode and the MLC mode.

The command analysis unit 16 analyzes the write command from the host 2 (S201). When the command analysis unit 16 determines that the SLC mode should not be applied (No in S202), the RW processing unit 13 writes all of the write data to the flash memory 20 in the MLC mode (S203).

When the command analysis unit 16 determines that the SLC mode should be applied (Yes in S202), the RW processing unit 13 determines whether the amount of the write data exceeds the threshold (S204). The threshold indicates the amount of data that can be written in the SLC mode without triggering GC. When the amount of write data does not exceed the threshold (No in S204), the RW processing unit 13 writes all of the write data to the flash memory 20 in the SLC mode (S205).

When the amount of the write data exceeds the threshold (Yes in S204), the RW processing unit 13 writes the twice of the amount exceeding the write data to the flash memory 20 in the MLC mode (S206) and writes the remaining write data to the flash memory 20 in the SLC mode (S207). The order of the write in the TLC mode in S206 and the write in the SLC mode in S207 may be reversed.

Similarly to the memory system 1 of the first embodiment, when writing all of the write data in the SLC mode may cause the performance degradation at the time of receiving write commands that should be applied to the SLC mode, the memory system 1-2 of the second embodiment performs some or all of write of write data in the MLC mode. This suppresses performance degradation.

In other words, the memory system 1-2 of the second embodiment can also appropriately control the write mode. Third Embodiment

Next, the third embodiment is described.

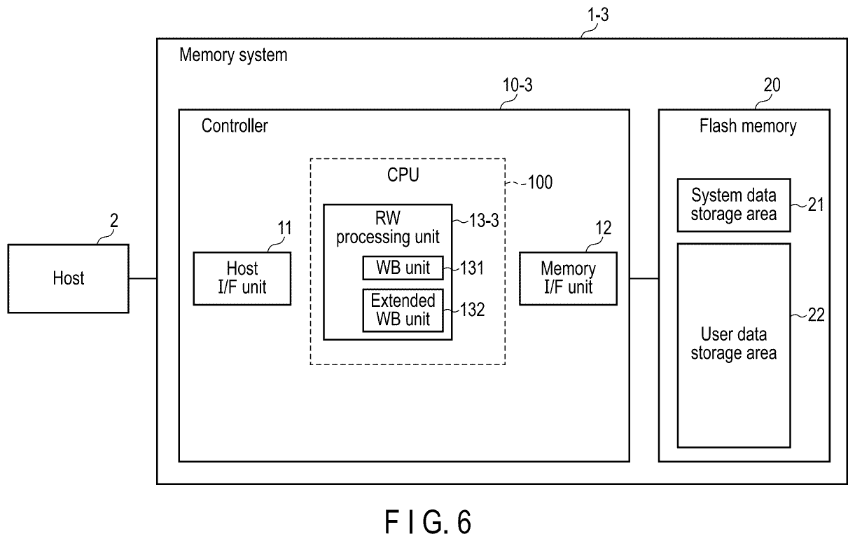

FIG. 6 is a diagram showing an example of a configuration of a memory system 1-3 of the third embodiment. The same reference numerals are used for the same constituent elements as those in the memory system 1 of the first embodiment, and their descriptions are omitted.

In a controller 10-3 of the third embodiment, an RW processing unit 13-3 further includes an extended WB unit 132. The extended WB unit 132 is a module provided to extend the WB functions implemented by a WB unit 131, and manages the second flag (fWriteBoosterMLC flag). The second flag is added uniquely to the memory system 1-3 of the third embodiment, which is not included in the current WB specification.

The second flag functions when the first flag (fWriteBoosterEn flag) is in the on state. When the first flag is in the off state, the second flag is also in the off state. Similarly to the first flag, the second flag can switch between the on state and the off state according to the commands from the host 2.

When the first flag is in the on state and the second flag is in the off state, the RW processing unit 13-3 writes the write data whose write is requested by the write command to a flash memory 20 in the SLC mode, as specified in the current WB specification.

On the other hand, when both of the first flag and the second flag are in the on state, the RW processing unit 13-3 writes the write data whose write is requested by the write command to the flash memory 20 in the MLC mode. That is, the memory system 1-3 of the third embodiment enables the host 2 to instruct not only write in the SLC mode but also write in the MLC mode.

When the first flag is in the off state, the RW processing unit 13-3 basically writes the write data whose write is requested by the write command to the flash memory 20 in the MLC mode. The specification does not limit this configuration. The RW processing unit 13-2 may also perform write in the SLC mode. Alternatively, when the memory system 1-3 supports the TLC mode, the RW processing unit 13-2 can perform write in the TLC mode as well.

FIG. 6 omits the illustration of a memory area management unit 14 and a GC processing unit 15. This does not signify that the controller 10-3 of the third embodiment does not have the memory area management unit 14 and the GC processing unit 15.

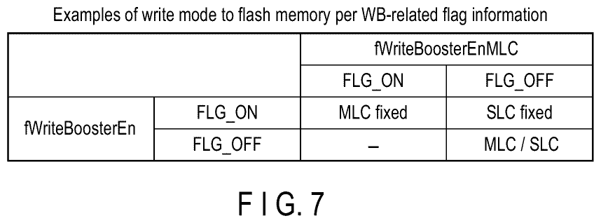

FIG. 7 is a diagram showing an example of a write mode for write to the flash memory 20 determined by the first flag (fWriteBoosterEn flag) and the second flag (fWriteBoosterMLC flag).

When the first flag is in the on state (FLG_ON) and the second flag is in the off state (FLG_OFF), the RW processing unit 13-2 writes the write data whose write is requested by the write command to the flash memory 20 in the SLC mode (SLC fixed).

Additionally, when both of the first flag and the second flag are in the on state, the RW processing unit 13-2 writes data in the MLC mode (MLC fixed).

When the first flag is in the off state, the RW processing unit 13-2 writes write data to the flash memory 20 in a given write mode (given write mode).

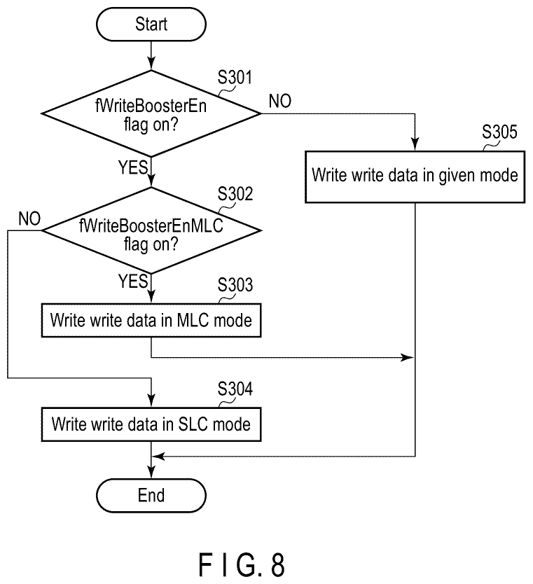

FIG. 8 is a flowchart showing the data write processing flow of the memory system 1-3 of the third embodiment.

The RW processing unit 13 determines whether the first flag (fWriteBoosterEn flag) is in the on state or not (S301). When the first flag is in the on state (Yes in S301), the RW processing unit 13 then determines whether the second flag (fWriteBoosterMLC flag) is in the on state or not (S302).

When the second flag is in the on state (Yes in S301), the RW processing unit 13 writes write data to the flash memory 20 in the MLC mode (S303). On the other hand, when the second flag is in the off state (No in S301), the RW processing unit 13 writes write data to the flash memory 20 in the SLC mode (S303).

Additionally, when the first flag is in the off state (No in S301), the RW processing unit 13 writes write data to the flash memory 20 in a given write mode (S305).

As described above, the memory system 1-3 of the third embodiment enables the host 2 to instruct not only write in the SLC mode but also write in the MLC mode.

That is, the memory system 1-3 of the third embodiment can also appropriately control the write mode.

### Fourth Embodiment

Next, the fourth embodiment is described.

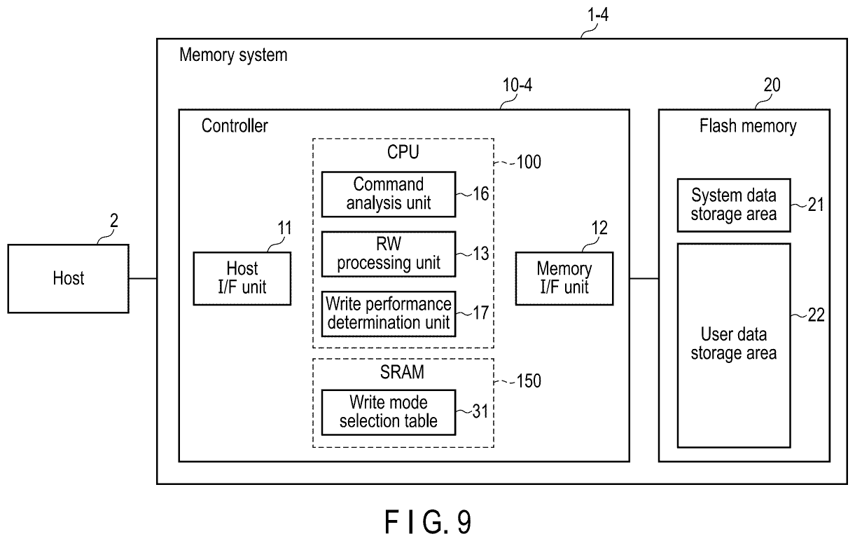

FIG. 9 is a diagram showing a configuration example of a memory system 1-4 of the fourth embodiment. The same constituent elements as those of the memory system 1-2 of the second embodiment are denoted by the same reference numerals and their descriptions are omitted.

Data transfer speed between a host 2 and the memory system 1-4 depends on the transfer rate set between the host 2 and the memory system 1-4. For example, even when write is performed in the SLC mode to achieve high performance of the SLC mode, depending on the transfer rate, only performance equivalent to or lower than that of the MLC mode is achieved.

To address this, a controller 10-4 of the fourth embodiment includes a write performance determination unit 17. The write performance determination unit 17 determines whether the write mode specified by the host 2 can achieve its maximum write performance based on the transfer rate. Further, the write performance determination unit 17 determines the write mode that has the best WAF among the write modes that can achieve their maximum write performance at that transfer rate. In other words, the write performance determination unit 17 determines the write mode with the best write performance per unit time. When the write performance per unit time of the write modes are almost equivalent due to the transfer rate limitation, the write performance determination unit 17 determines the write mode with the lowest WAF. In the memory system 1-4 of the fourth embodiment, the RW processing unit 13 switches the write mode as necessary based on the determination result of the write performance determination unit 17.

For example, in the Mobile Industry Processor Interface (MIPI™) standard, the transfer rate is referred to as a gear, and in the Universal Flash Storage (UFS) 4.0 standard, five transfer rates, HS-GEAR 1 to HS-GEAR5, are defined. The HS-GEAR1 is the slowest transfer rate, and the HS-GEAR5 is the fastest transfer rate.

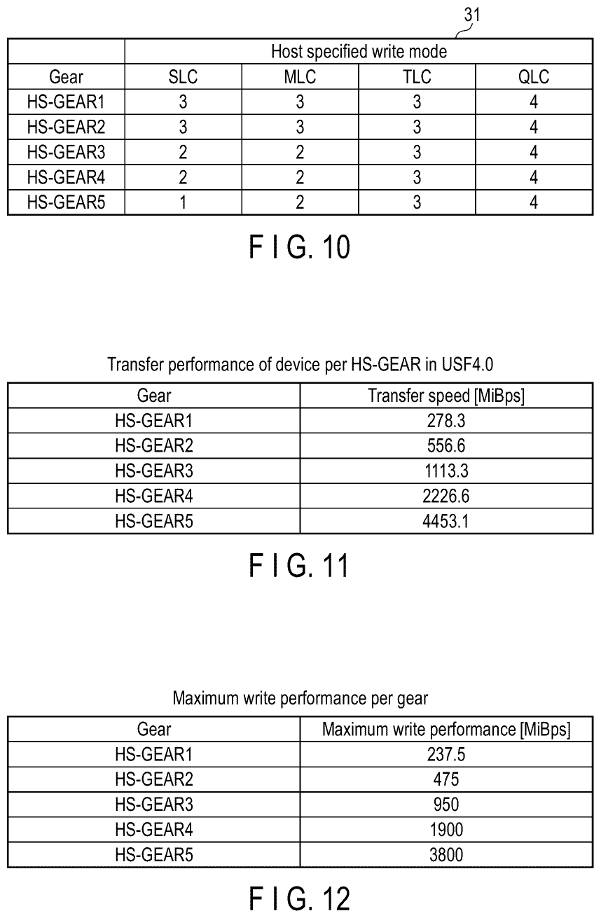

Further, the controller 10-4 of the fourth embodiment has a write mode selection table 31. FIG. 10 is an example of the write mode selection table 31.

For example, the write mode selection table 31 is provided in Static Random Access Memory (SRAM) in the controller 10-4. The write performance determination unit 17 refers to the write mode selection table 31 to determine the write mode with its maximum write performance based on the transfer rate.

As shown in FIG. 10, the write mode selection table 31 stores data in which numbers 1 to 4 are arranged in a matrix. For example, the vertical axis of the data represents gears and the horizontal axis represents the write modes specified by the host 2. For example, among the numbers 1 to 4, 1 indicates the SLC mode, 2 indicates the MLC mode, 3 indicates the TLC mode, and 4 indicates the QLC mode.

For example, when the gear is HS-GEAR1 and the write mode specified by the host 2 is the SLC mode or the MLC mode, the SLC mode and the MLC mode cannot achieve their maximum write performance. In this case, the TLC mode can achieve the maximum write performance. Thus, the write performance determination unit 17 refers to the write mode selection table 31 and decides to switch the write mode from the SLC mode or the MLC mode to the TLC mode. When the TLC or the QLC, which can achieve their maximum write performance, is selected as the write mode, the write performance determination unit 17 refers to the write mode selection table 31 and decides not to switch the write mode.

In other words, the write mode selection table 31 stores information (1 to 4) indicating the actual write mode to be applied for each combination of the gear and the writing mode specified by the host 2.

As with HS-GEAR1, when the gear is HS-GEAR2, the SLC mode and the MLC mode cannot achieve their maximum write performance. In contrast, in this state, the TLC mode and the QLC mode can achieve their maximum write performance. Thus, when the SLC mode or the MLC mode are selected, the write mode is switched to the TLC mode. In contrast, when the TLC mode or the QLC mode is selected, the wire mode is not switched.

When the gear is HS-GEAR3 or HS-GEAR4, the MLC mode can achieve its maximum write performance. Thus, only when the SLC mode is selected, the write mode is switched to the TLC mode. When the MLC mode, the TLC mode, or the QLC mode is selected, the write mode is not switched.

When the gear is HS-GEAR5, the SLC mode also can achieve its maximum write performance. Thus, the write mode is not switched regardless of the specified write mode.

FIG. 11 is a diagram showing the transfer performance of devices for each gear (HS-GEAR) specified in the UFS 4.0 standard. As an example, the following shows a device of RateB-series with REF_CLK frequency value of 38.4 MHz, and 2 Lane.

System updates, header overhead, and other factors make the write performance of the SLC mode 3800 MiBps. Thus, the overhead is regarded as 0.1467s, and the maximum write performance for each gear is regarded as that shown in FIG. 12. FIG. 12 is a diagram showing the maximum write performance for each gear.

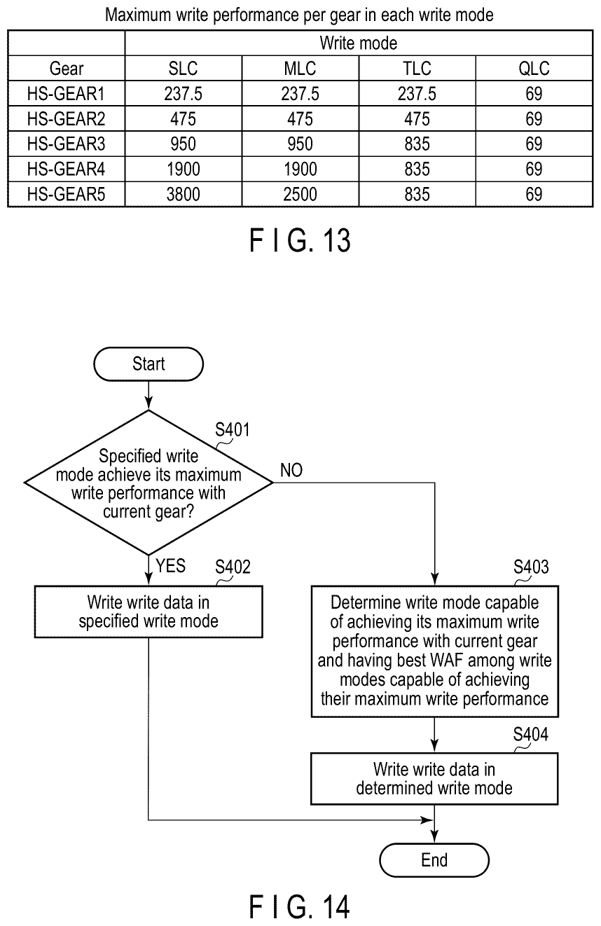

FIG. 13 is a diagram showing the write performance for each gear in each write mode.

The write performance of the HS-GEAR4 is the same in the SLC mode and in the MLC mode, indicating that the write performance is limited by the gear. In this case, the SLC mode can only achieve the same performance as the MLC mode, and its WAF is worse than the MLC mode. Thus, the MLC mode is selected.

Specifically, when the gear is HS-GEAR4 and the SLC mode is specified by the host 2, the write performance determination unit 17 selects the MLC mode as the write mode based on the write mode selection table 31.

FIG. 14 is a flowchart showing the data write processing flow of the memory system of the fourth embodiment.

The write performance determination unit 17 determines whether the write mode specified by the host 2 can achieve its maximum write performance with the current gear based on the write mode selection table 31 (S401). When the write performance determination unit 17 has determined that the specified write mode can achieve its maximum write performance (Yes in S401), the RW processing unit 13 writes write data to the flash memory 20 in the specified write mode (S402).

When the write performance determination unit 17 has determined that the specified write mode cannot achieve its maximum write performance (No in S401), the write performance determination unit 17 selects the write mode that can achieve its maximum write performance with the current gear and has the best WAF among the write modes that can achieve their maximum write performance, based on the write mode selection table 31 (S403). The RW processing unit 13 writes write data to the flash memory 20 in the determined write mode (S404).

The above describes examples in which, when the selected write mode cannot achieve its maximum write performance due to the gear, the write mode is switched to the write mode with the best WAF that can achieve its maximum write performance in the same gear, regardless of the write mode specified by the host 2. A modified example may have the following configuration: when a write mode is specified by the host 2, the specified write mode is selected, and when no write mode is specified, the write mode with the best WAF that can achieve its maximum write performance is selected.

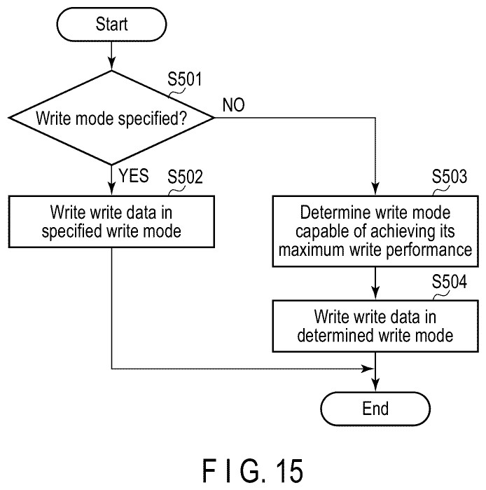

FIG. 15 is a flowchart showing the modified example of the data write processing flow of the memory system of the fourth embodiment.

The RW processing unit 13 determines whether the host 2 specifies the write mode (S501). When the write mode is specified (Yes in S501), the RW processing unit 13 writes write data to the flash memory 20 in the specified write mode (S502).

When the write mode is not specified by the host 2 (No in S501), the write performance determination unit 17 determines the write mode that can achieve its maximum write performance based on the write mode selection table 31 (S503). The RW processing unit 13 writes write data to the flash memory 20 in the determined write mode (S504).

As described above, in light of the limit of the write performance due to the gear, when the write mode specified by the host 2 cannot achieve its maximum write performance, the memory system 1-4 of the fourth embodiment switches the write mode to the write mode that can achieve its maximum write performance with the current gear and has the best WAF among the write modes that can achieve their maximum write performance.

That is, the memory system 1-4 of the fourth embodiment can also appropriately control the write mode.

### Fifth Embodiment

Next, the fifth embodiment is described.

The fifth embodiment is an application example of a memory system 1-2 of the second embodiment. The second embodiment shows an example in which write mode for part of the write of write data is switched from the SLC mode to the MLC mode such that the write of write data to the flash memory 20 can be completed without triggering GC.

In contrast, if GC still occurs even when the write mode is switched from the SLC mode to the MLC mode, the fifth embodiment uses the TLC mode to further delay the occurrence of GC.

This write mode control aims to prevent decrease in the write performance due to the occurrence of GC. Thus, the entire write mode of write of write data may be switched to the MLC mode depending on the situation. When GC still occurs even when the write mode of the write of all of the write data is switched to the MLC mode, switching the write mode of the write of all of the write data to the TLC mode can delay the occurrence of GC.

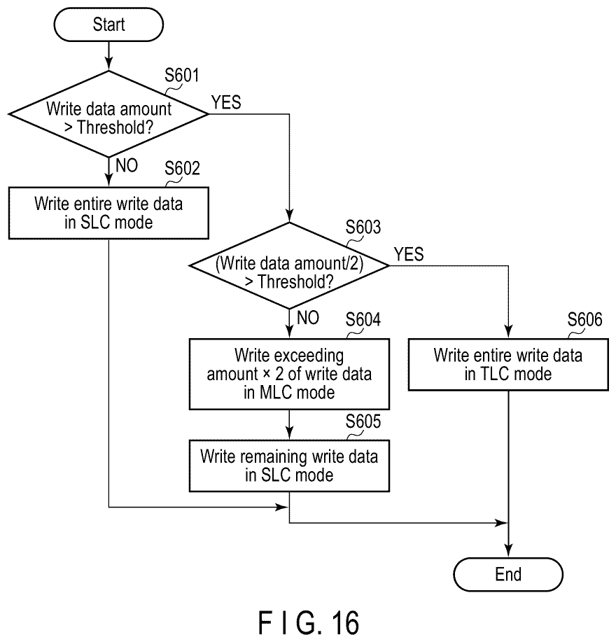

FIG. 16 is a flowchart showing the data write processing flow of the memory system of the fifth embodiment.

The RW processing unit 13 determines whether the amount of the write data exceeds the threshold (S601). When the amount of the write data does not exceed the threshold (No in S601), the RW processing unit 13 writes all of the write data to the flash memory 20 in the SLC mode (S602).

When the amount of the write data exceeds the threshold (Yes in S601), the RW processing unit 13 then determines whether half of the write data exceeds the threshold (S603). When half of the write data does not exceed the threshold (No in S603), the RW processing unit 13 writes the twice of the amount of the write data exceeding the threshold to the flash memory 20 in the MLC mode (S604), and writes the remaining write data to the flash memory 20 in the SLC mode (S605). The order of the write in the MLC mode in S604 and the write in the SLC mode in S605 may be reversed.

When half of the write data exceeds the threshold (Yes in S603), the RW processing unit 13 writes all of the write data to the flash memory 20 in the TLC mode (S606).

As described above, the memory system 1-2 of the fifth embodiment further delays the occurrence of GC by utilizing the TLC writing.

In other words, the memory system 1-2 of the fifth embodiment can also control the write mode appropriately.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is

1. A memory system comprising:
a nonvolatile memory including a plurality of blocks each including a plurality of memory cells; and
a memory controller configured to be capable of connecting to a host, and control the nonvolatile memory, wherein
the memory controller is configured to
support a first write mode and a second write mode as a data write mode to the nonvolatile memory, the first write mode being a mode which writes 1 bit of data to each memory cell, the second write mode being a mode which writes N (N is a natural number of 2 or more) bits of data to each memory cell, and
when receiving a write command from the host to be applied to the first write mode,
determine whether or not amount of write data exceeds a threshold, the threshold being obtained by subtracting a predetermined value from remaining capacity of the nonvolatile memory, the predetermined value indicating remaining capacity of the nonvolatile memory at which garbage collection is triggered to increase remaining capacity of the nonvolatile memory;
when the amount of the write data is equal to or less than the threshold, write the write data to the nonvolatile memory in the first write mode, and
when the amount of the write data exceeds the threshold, write at least (amount exceeding over the threshold)+((amount exceeding over the threshold)/(the N−1)) of the write data to the nonvolatile memory in the second write mode, and write remaining of the write data to the nonvolatile memory in the first write mode.

2. The memory system of claim 1, wherein
the memory controller is configured to:
manage a first flag capable of switching between an on state and an off state according to a command from the host; and
determine that the first write mode is to be applied to the write command received from the host while the first flag is in the on state.

3. The memory system of claim 2, wherein
the memory controller is configured to:
manage a second flag capable of switching between an on state and an off state by a command from the host; and
when the first flag is in the on state and the second flag is in the off state, determine that the first write mode is to be applied to the write command received from the host, and
when the second flag is in the on state, determine that the second write mode is to be applied to the write command received from the host.

4. The memory system of claim 2, wherein
the memory controller is configured to:
when the write command received from the host is a write command to which the first write mode is applied, and when write performance to the nonvolatile memory in the first write mode expectedly becomes equal to or less than write performance to the nonvolatile memory in the second write mode, based on a transfer rate adopted in communication with the host, determine that the second write mode is to be applied to the write command received from the host.

5. The memory system of claim 1, wherein
the memory controller is configured to:
support a third write mode as a data write mode to the nonvolatile memory, the third write mode being a mode which writes K (K is a natural number more than N) bits of data to each memory cell, and
when amount of the write data exceeds the threshold and when writing all of the write data to the nonvolatile memory in the second write mode makes the remaining capacity of the nonvolatile memory below the predetermined value, write all of the write data to the nonvolatile memory in the third write mode.

6. A memory controller configured to be capable of connecting to a host, and control a nonvolatile memory including a plurality of blocks each including a plurality of memory cells, the memory controller being configured to:
support a first write mode and a second write mode as a data write mode to the nonvolatile memory, the first write mode being a mode which writes 1 bit of data to each memory cell, the second write mode being a mode which writes N (N is a natural number of 2 or more) bits of data to each memory cell; and
when receiving a write command from the host to be applied to the first write mode,
determine whether or not amount of write data exceeds a threshold, the threshold being obtained by subtracting a predetermined value from remaining capacity of the nonvolatile memory, the predetermined value indicating remaining capacity of the nonvolatile memory at which garbage collection is triggered to increase remaining capacity of the nonvolatile memory,
when the amount of the write data is equal to or less than the threshold, write the write data to the nonvolatile memory in the first write mode, and
when the amount of the write data exceeds the threshold, write at least (amount exceeding over the threshold) +((amount exceeding over the threshold)/(the N-1)) of the write data to the nonvolatile memory in the second write mode, and write remaining of the write data to the nonvolatile memory in the first write mode.

7. The memory controller of claim 6, configured to:
manage a first flag capable of switching between an on state and an off state according to a command from the host; and
determine that the first write mode is to be applied to the write command received from the host while the first flag is in the on state.

8. The memory controller of claim 7, configured to:
manage a second flag capable of switching between an on state and an off state by a command from the host, and
when the first flag is in the on state and the second flag is in the off state, determine that the first write mode is to be applied to the write command received from the host, and
when the second flag is in the on state, determine that the second write mode is to be applied to the write command received from the host.

9. The memory controller of claim 7, configured to:
when the write command received from the host is a write command to which the first write mode is applied, and when write performance to the nonvolatile memory in the first write mode expectedly becomes equal to or less than write performance to the nonvolatile memory in the second write mode, determine that the second write mode is to be applied to the write command received from the host.

10. The memory controller of claim 6, configured to:
support a third write mode as a data write mode to the nonvolatile memory, the third write mode being a mode which writes K (K is a natural number more than N) bits of data to each memory cell; and
when amount of the write data exceeds the threshold and when writing all of the write data to the nonvolatile memory in the second write mode makes the remaining capacity of the nonvolatile memory below the predetermined value, write all of the write data to the nonvolatile memory in the third write mode.
